(19) United States
(12) Patent Application Publication
(10) Pub. No.: US 2020/0401953 A1
(43) Pub. Date: Dec. 24, 2020

(54) INFORMATION PROCESSING SYSTEM AND NON-TRANSITORY COMPUTER READABLE MEDIUM STORING PROGRAM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/598,052

(22) Filed: Oct. 10, 2019

(30) Foreign Application Priority Data
Jun. 19, 2019 (JP) 2019-114047

(51) Int. Cl. G06Q 10/02; G06K 9/00

(52) U.S. Cl. CPC G06Q 10/02; G06K 9/00288; G06K 9/00362

(57) ABSTRACT

An information processing system includes a grasping unit that grasps usages of a specific place that is used by users, and a user detector that detects plural users who use the specific place at different time points and satisfy a predetermined specific condition based on the usages grasped by the grasping unit.

### CROSS-REFERENCE TO RELATED APPLICATIONS

This application is based on and claims priority under 35 USC 119 from Japanese Patent Application No. 2019-114047 filed Jun. 19, 2019.

### BACKGROUND

### (i) Technical Field

The present disclosure relates to an information processing system and a non-transitory computer readable medium storing a program.

### (ii) Related Art

Japanese Unexamined Patent Application Publication No. 2002-150178 discloses a rental system including a reservation server that makes a reservation for rental of a desired property out of rental properties and offered rental properties that are publicly announced by a public server.

Japanese Unexamined Patent Application Publication No. 2004-086582 discloses a rental booth that provides a space available to a user for a predetermined period. The rental booth includes a user authentication unit, an electric lock for management of entry to and exit from the space, and a computer terminal to be used by the user.

### SUMMARY

Aspects of non-limiting embodiments of the present disclosure relate to the following circumstances. A camera or the like is arranged in a place to be used by users to identify the users who use the place. In this case, each individual user is identified separately.

It is desirable to identify a plurality of users who use a specific place at different time points and satisfy predetermined specific conditions.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising a grasping unit that grasps usages of a specific place that is used by users, and a user detector that detects a plurality of users who use the specific place at different time points and satisfy a predetermined specific condition based on the usages grasped by the grasping unit.

### BRIEF DESCRIPTION OF THE DRAWINGS

An exemplary embodiment of the present disclosure will be described in detail based on the following figures, wherein:

FIG. 1 schematically illustrates an example of the overall configuration of an information processing system;

FIG. 2 illustrates an example of a space;

FIG. 3 illustrates an example of the hardware configuration of each management server;

FIG. 4 illustrates an example of the hardware configuration of a user terminal;

FIG. 5 illustrates an example of the functional configuration of a space management server;

FIG. 6 illustrates an example of a flow of processing to be performed by the space management server;

FIG. 7 illustrates an example of usages of one space;

FIG. 8 is a flowchart illustrating a flow of processing of detecting users by a user detection part;

FIG. 9 illustrates an example of usages of the space;

FIG. 10 illustrates an example of usages of the space;

FIG. 11 is a flowchart illustrating a flow of processing of detecting a plurality of users involved in object delivery; and

FIG. 12 illustrates usages of the space.

### DETAILED DESCRIPTION

An exemplary embodiment of the present disclosure is described below with reference to the drawings.

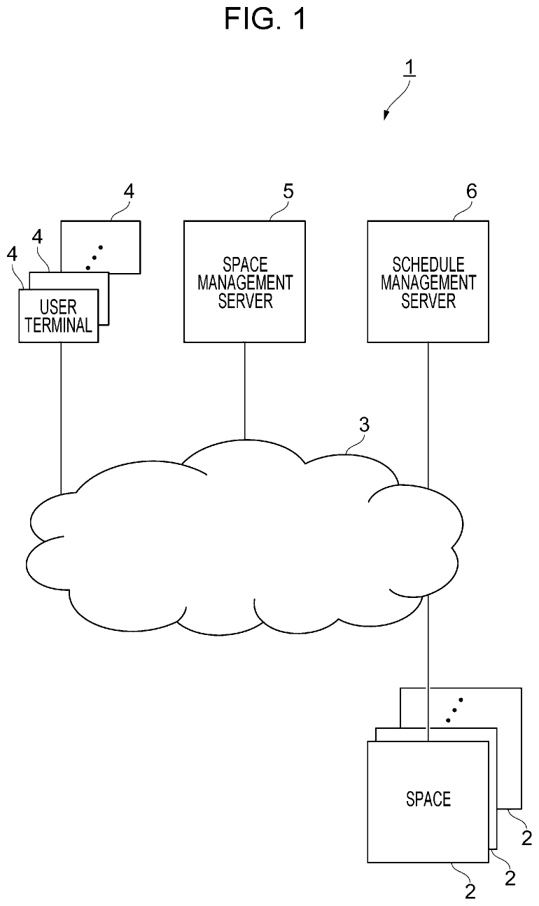

FIG. 1 schematically illustrates an example of the overall configuration of an information processing system 1 according to this exemplary embodiment.

In this exemplary embodiment, a plurality of spaces 2 are provided as examples of a specific place to be used by users.

The spaces 2 include a booth, a room of an accommodation or the like, and a conference room of a company or the like. Those spaces are examples of a space demarcated from surroundings with walls, partitions, or the like. The spaces 2 of this exemplary embodiment include a table and a seat in a restaurant or a barbershop where a service is provided. Those spaces are examples of a space open to surroundings.

The space 2 of this exemplary embodiment is assigned a name, a number, or the like for management. Reservation of the space 2 may be chargeable or free of charge.

The information processing system 1 illustrated in FIG. 1 includes various terminals connected to a cloud network 3.

As examples of the terminals connected to the cloud network 3, FIG. 1 illustrates user terminals 4 operated by users, a space management server 5 that manages the spaces 2, and a schedule management server 6 that manages schedules of users who are reserving persons.

In the case of FIG. 1, one server is prepared for each purpose or function. That is, one space management server 5 and one schedule management server 6 are prepared.

A plurality of servers may be prepared for one purpose or function or one server may be shared for a plurality of purposes or functions.

The number of business entities that manage a certain space 2 may be one or plural. For example, different business entities may individually have responsibilities for management of reservations, management of entry/exit and usages of rooms, management of charges for use on users, and management of members registered as users.

As described above, the spaces 2 to be managed for reservation need not be the same type of space. For example, a subset of the spaces 2 may be booths and another subset of the spaces 2 may be a seat and a table in a restaurant or the like.

A plurality of business entities may offer management of one purpose or function in cooperation.

If an electronic lock is attached to a door of the space 2, the space 2 is available under a condition that the user has an electronic key provided in advance. If the space 2 has no door, the space 2 is available, for example, under a condition that the reserving person is authenticated by using an authentication code provided in advance or a manager of the space 2 verifies the name of the reserving person.

In this exemplary embodiment, the user terminal 4 is assumed to be a smartphone to be carried by a user who is a reserving person. The portable user terminal 4 may be a so-called wearable terminal, a notebook computer, or a game console.

The space management server 5 manages various types of information related to the space 2. For example, the space management server 5 manages information for identifying a user, information for identifying the space 2 for reservation, start time and date of reservation, and end time and date of reservation.

Examples of the information for identifying a user include a name, sex, and age of the user, an account, a password, and individual management information. Examples of the information for identifying the space 2 for use include information for identifying an address or a location, a management name, and a management number.

The space management server 5 may manage reservation of an article or service associated with the space 2. For example, the space management server 5 may manage a lendable or licensable article or service or a consumable article or service.

The space management server 5 manages various types of information related to use of the space 2. For example, the space management server 5 manages information on a usage of the space 2 and information on a user who uses the space 2.

The schedule management server 6 is a terminal to be executed by, for example, an application or groupware to be used for management of a schedule by a user who is a reserving person. If the user's schedule is managed by using an application installed in the user terminal 4, the schedule management server 6 is unnecessary. For example, the schedule management server 6 stores an account and a password of the user for management, the subject of the schedule, a place for a scheduled event, start time and date, and end time and date.

### <External Structure of Space 2>

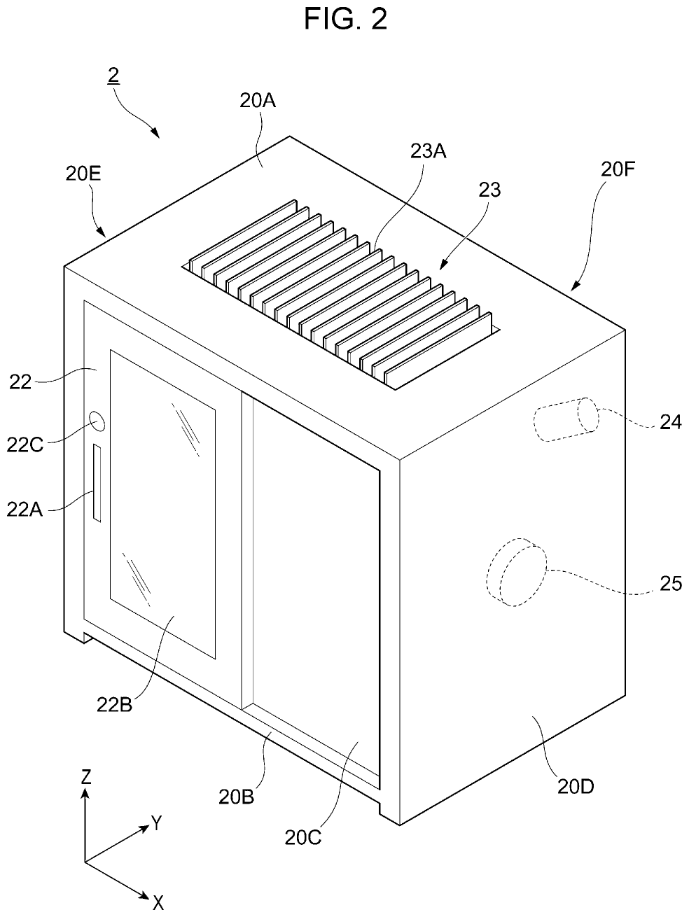

FIG. 2 illustrates an example of a booth type space 2. The booth type space 2 illustrated in FIG. 2 is arranged irrespective of indoors or outdoors. For example, the booth type space 2 is arranged in a station yard, an airport, an office building, a commercial facility such as a restaurant or a department store, a bank, a library, an art gallery, a museum, a public institution or facility, an accessway, or a park.

The booth type space 2 illustrated in FIG. 2 is a closed booth having a ceiling. The term “closed” does not mean “sealed” and the closed booth only needs to have a practical sound-proof property. Therefore, an opening or clearance such as an air vent or a small window may be provided in a portion of a frame that defines the space 2. The window may be openable and closable.

The frame of the space 2 illustrated in FIG. 2 includes a ceiling 20A, a floor 20B, a wall 20C having an openable and closable door 22, two walls 20D and 20E located on both sides of the wall 20C, and a wall 20F located opposite the door 22.

In the case of FIG. 2, the ceiling 20A has a ventilating hole 23. A louver 23A capable of adjusting the opening area is attached to the ventilating hole 23. The louver 23A of FIG. 2 is fully open.

In this exemplary embodiment, the door 22 is assumed to be a sliding door movable along the wall 20C. In the case of FIG. 2, the door 22 is a single sliding door that slides in one direction. The door 22 may be a double sliding door to be opened or closed by moving two or more members in different directions, or a drawn door having two members slidable to right and left.

The door 22 is not limited to the sliding door. For example, the door 22 may be a single hinged door having one swingable member, or a double hinged door having one opening closed by two door members.

The door 22 may be a folding door to be opened by folding a pair of door members coupled by hinges. The folding door may be a folding door of a type in which door members are opened in one direction, or in which door members are opened in two directions.

As a special type of door, the door 22 may be a partition door or a retractable sliding door to be retracted into a wall when the door 22 is opened.

The door 22 may be opened inward or outward.

In this exemplary embodiment, the door 22 has a handle 22A to be gripped by a user when the door 22 is opened or closed.

A member 22B subjected to treatment in consideration of confidentiality and security is arranged at the center of the door 22. For example, the member 22B may be a transparent plate in which a metal plate having many arrays of holes (for example, a perforated metal) is attached on an inner side, a transparent plate in which a screen member is attached on an inner side with a clearance, a transparent plate having a film that makes it easy to view the inside from the front but difficult to view the inside in a slanting direction, or a transparent plate subjected to treatment for reducing internal visibility.

For example, glass or an acrylic resin is used for the transparent plate. A characteristic related to the transparency of the film bonded for confidentiality and security is determined based on a relationship between the position of the door 22 and the working position of the user. If the user works on a far side behind the front of the door 22, it is appropriate to use a film that makes it difficult to view the inside from the front but easy to view the inside in a slanting direction.

The film may be a liquid crystal film whose transparent state and opaque state are switchable electrically, or a polarizing film whose transmittance is controllable electrically.

Examples of the treatment for reducing visibility include finely scoring the surface of the member so that light is scattered.

The treatment may be performed on a portion of the member 22B. For example, the structure may be provided such that the member 22B is transparent near the floor and the ceiling and the visibility is reduced through the treatment in a range in which a monitor may be viewed during work.

By arranging the member 22B, the presence or absence of the user may be confirmed from the outside while hiding a screen of the monitor from the outside.

An electronic lock 22C unlockable with an electronic key is attached to the door 22.

The treatment in consideration of confidentiality and security may be performed on a member other than the door 22. For example, the treatment in consideration of confidentiality and security may be performed on at least a portion of the wall 20D, 20E, or 20F.

The number of users of the space 2 is roughly determined depending on the volume of the space 2. The space 2 of this exemplary embodiment is assumed to be a private room that is basically used alone. The space 2 may be a large room capable of accommodating many people. The large room may be formed as a single room but may be formed by removing one or both of the walls 20D and 20E of the space 2 and coupling a plurality of spaces 2.

The private room does not mean that the room may be used alone but means that the room may be used by a few people such as two or three people.

The shape and structure of the frame that defines the space 2 and the provided equipment and performance thereof are arbitrary. For example, the ceiling 20A may be omitted.

In this exemplary embodiment, one desk and one chair (not illustrated) are arranged in the frame. Furnished equipment and devices or reserved equipment and devices are arranged on the desk.

A photographing apparatus 24 such as a camera that photographs the inside of the frame and a motion sensor 25 that detects a user in the frame are provided in the frame. An information acquisition apparatus that acquires information on each user of the space 2 may be provided on an outer side of the frame. For example, the information acquisition apparatus is a reader that reads an ID card held over the reader. The information acquisition apparatus may be a reader that reads a fingerprint or a vein pattern of a user.

In this exemplary embodiment, pieces of information on a usage of the space 2 are sequentially transmitted to the space management server 5 and stored in a usage storage part (described later) of the space management server 5.

In other words, in this exemplary embodiment, pieces of information acquired by various apparatuses and the motion sensor 25 installed in the space 2 are sequentially transmitted to the space management server 5 and stored in the usage storage part of the space management server 5.

In this exemplary embodiment, the pieces of information stored in the usage storage part are analyzed to grasp the usage of the space 2.

### <Configurations of Terminals>

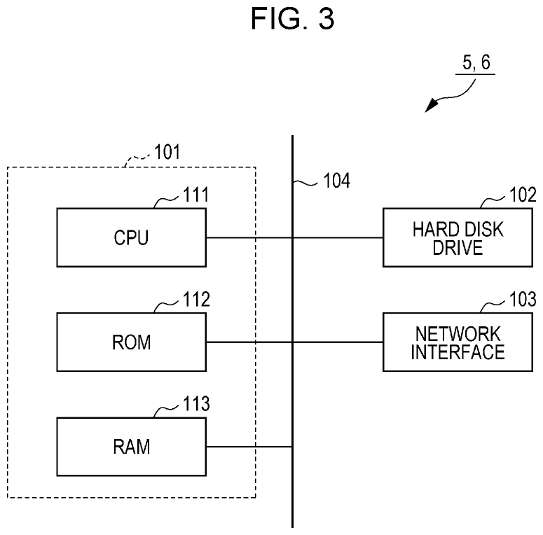

FIG. 3 illustrates an example of the hardware configuration of each management server for use in the exemplary embodiment. The management servers of this exemplary embodiment are the space management server 5 (see FIG. 1) and the schedule management server 6 (see FIG. 1).

The management server includes a control unit 101 that controls an overall operation of the apparatus, a hard disk drive 102 that stores management data and the like, and a network interface 103 that achieves communication via a local area network (LAN) cable or the like.

The control unit 101 includes a central processing unit (CPU) 111, a read only memory (ROM) 112 that stores basic software, a basic input/output system (BIOS), and the like, and a random access memory (RAM) 113 to be used as a working area. The CPU 111 may be a multi-core CPU. The ROM 112 may be a rewritable non-volatile semiconductor memory. The control unit 101 is a so-called computer.

The hard disk drive 102 is an apparatus that reads and writes data on a non-volatile storage medium obtained by applying a magnetic substance to the surface of a disc-shaped substrate. The non-volatile storage medium may be a semiconductor memory or a magnetic tape.

As necessary, the management server includes an input device such as a keyboard and a mouse, and a display device such as a liquid crystal display.

The control unit 101, the hard disk drive 102, and the network interface 103 are connected through a bus 104 and signal lines (not illustrated).

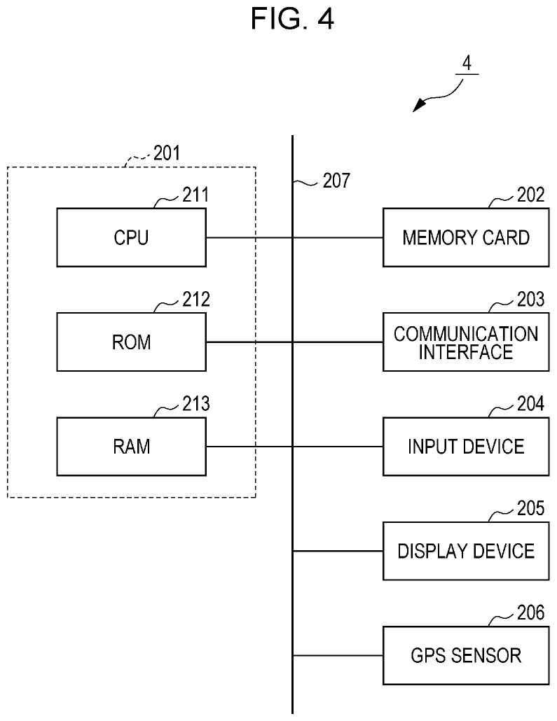

FIG. 4 illustrates an example of the hardware configuration of the user terminal 4. The configuration illustrated in FIG. 4 is assumed to be a configuration when the user terminal 4 is a smartphone.

The user terminal 4 includes a control unit 201 that controls an overall operation of the apparatus, a memory card 202 that stores various types of data, various types of communication interface 203 conforming to wireless communication standards, an input device 204 such as a touch sensor, a display device 205 such as a liquid crystal display or an organic electroluminescence (EL) display, and a Global Positioning System (GPS) sensor 206.

The control unit 201 includes a CPU 211, a ROM 212 that stores firmware, a BIOS, and the like, and a RAM 213 to be used as a working area. The CPU 211 may be a multi-core CPU. The ROM 212 may be a rewritable non-volatile semiconductor memory.

For example, the communication interface 203 is an interface to be used for connection to a mobile communication system, or an interface to be used for connection to a wireless LAN.

The GPS sensor 206 measures the position of the user terminal 4 by receiving an electric wave from a GPS satellite. Information on a latitude, a longitude, and an altitude output from the GPS sensor 206 provides a current position of the user terminal 4. The GPS sensor 206 may be compatible with an indoor positioning system.

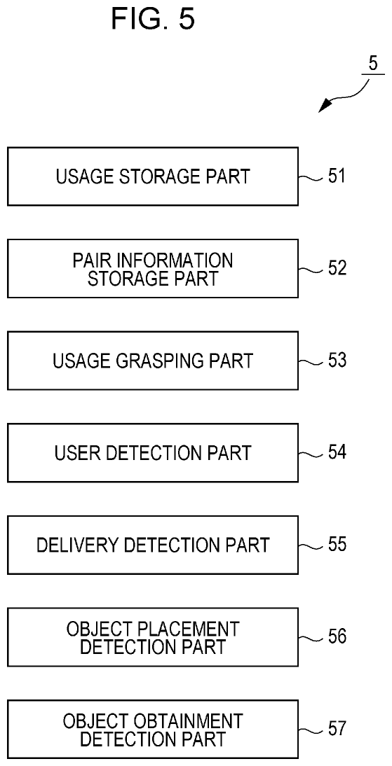

FIG. 5 illustrates an example of the functional configuration of the space management server 5 (see FIG. 1).

The space management server 5 includes a usage storage part 51, a pair information storage part 52, a usage grasping part 53, a user detection part 54, a delivery detection part 55, an object placement detection part 56, and an object obtainment detection part 57.

For example, the usage storage part 51 is implemented by the hard disk drive 102 (see FIG. 3). In this exemplary embodiment, pieces of information acquired by various apparatuses and the motion sensor 25 installed in the space 2 are sequentially output to the space management server 5 and stored in the usage storage part 51.

For example, the pair information storage part 52 is implemented by the hard disk drive 102 (see FIG. 3). The pair information storage part 52 stores information on a pair generated by the user detection part 54 (details are described later).

The usage grasping part 53, the user detection part 54, the delivery detection part 55, the object placement detection part 56, and the object obtainment detection part 57 are implemented through execution of a program by the control unit 101.

The usage grasping part 53 that is an example of a grasping unit grasps usages of the space 2 that is used by users.

The user detection part 54 that is an example of a user detector detects a plurality of users who use the space 2 at different time points and satisfy predetermined specific conditions based on the usages grasped by the usage grasping part 53.

The delivery detection part 55 that is an example of a delivery detector detects that an object is delivered via the space 2.

The object placement detection part 56 that is an example of an object placement detector detects that an object is placed in the space 2.

The object obtainment detection part 57 that is an example of an object obtainment detector detects that an object placed in the space 2 is obtained.

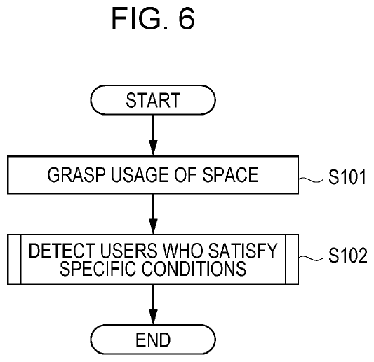

FIG. 6 illustrates an example of a flow of processing to be performed by the space management server 5.

In the processing of this exemplary embodiment, the usage grasping part 53 reads information from the usage storage part 51 at every predetermined timing such as every one minute to grasp a usage of the space 2 that is an example of a specific place at every predetermined timing (Step S101).

More specifically, the space 2 of this exemplary embodiment is used by a plurality of different users. At every predetermined timing, the usage grasping part 53 acquires information on a usage of the space 2 that is used by each of the plurality of different users.

In this exemplary embodiment, the user detection part 54 detects users who satisfy the specific conditions based on the usages acquired by the usage grasping part 53 (Step S102).

Specifically, the user detection part 54 detects a plurality of users who use the space 2 at different time points and satisfy the predetermined specific conditions.

In this exemplary embodiment, the space 2 is used sequentially by a plurality of users.

The user detection part 54 detects, among the plurality of users who sequentially use the space 2, a plurality of users who use the space 2 at different time points and satisfy the predetermined specific conditions.

More specifically, the user detection part 54 detects a plurality of users who use the space 2 a plurality of times at different time points.

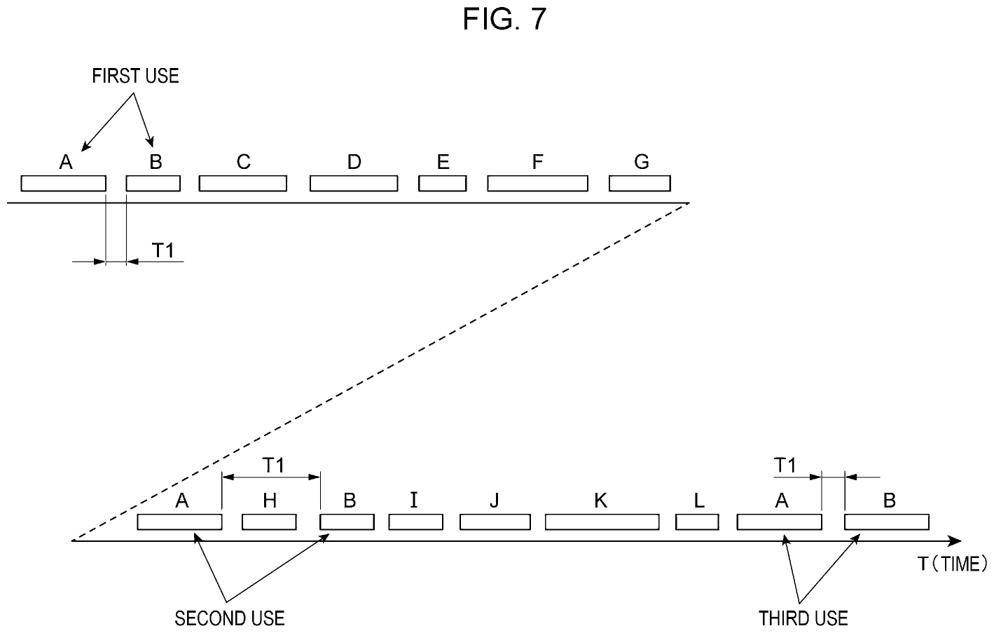

FIG. 7 illustrates an example of usages of one space 2. In FIG. 7, the horizontal axis represents an elapse of time. In FIG. 7, the rectangles represented by reference symbols indicate that the space 2 is actually used.

In this example, the space 2 is used by users A, B, C, D, E, F, G, A, H, B, I, J, K, L, A, and B in this order.

In those usages, the user detection part 54 detects the users A and B as the plurality of users.

The users A and B use the space 2 at different time points. Further, the users A and B use the space 2 a plurality of times (three times in this example) at different time points.

In this case, the user detection part 54 detects the users A and B.

In this exemplary embodiment, the user detection may involve processing of identifying images obtained by photographing the users A and B as well as, for example, detecting the names of the users A and B.

In this exemplary embodiment, the “user detection” includes identifying individual users by acquiring information that is not registered in advance but may be used for identifying the users, such as face photographs, as well as identifying the users by acquiring information that is registered in advance, such as users' names.

For example, the information such as users' names may be acquired from reservation information of the space 2 or information obtained by reading ID cards of the users. For example, the face photographs may be acquired from photographing results of the photographing apparatus 24.

For example, an illegal object may be exchanged by using the space 2. More specifically, a preceding user who uses the space 2 first may place the illegal object in the space 2 and then a succeeding user who uses the space 2 later may receive the object.

Such exchange may take place not only once but also a plurality of times by the plurality of same users. In other words, the exchange may take place a plurality of times by the same pair.

In those cases, it is more likely that the plurality of users who exchange the object are detected if the plurality of users who use the space a plurality of times at different time points may be identified as in this exemplary embodiment.

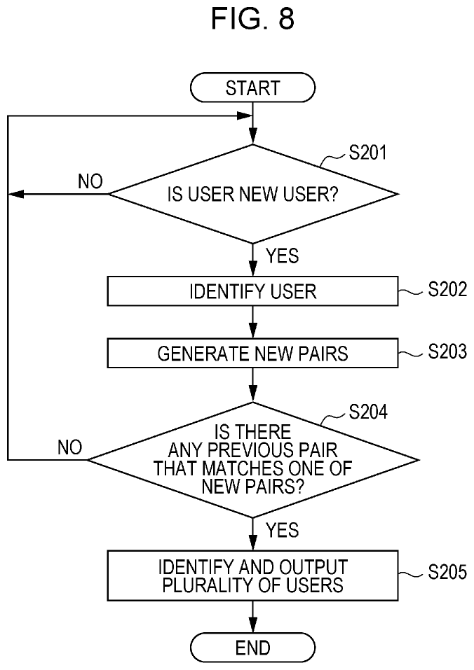

FIG. 8 is a flowchart illustrating a flow of processing of detecting users by the user detection part 54. In other words, FIG. 8 is a flowchart illustrating details of the processing in Step S102.

In this exemplary embodiment, the user detection part 54 determines whether a user is a new user every time a new usage is grasped by the usage grasping part 53 (Step S201).

In other words, the user detection part 54 determines whether the user who uses the space 2 is switched to a new user. If the user is a new user, the user detection part 54 identifies the user (Step S202). As described above, the user identification includes acquiring, for example, a face photograph of the user.

Subsequently, the user detection part 54 generates pairs of users (referred to as “new pairs”) by combining previous users and the identified new user (Step S203).

More specifically, the user detection part 54 identifies previous users who have used the space 2 within three hours before a time point when the new user uses the space 2 and generates new pairs by combining the previous users and the new user.

This exemplary embodiment is directed to the case in which two users are combined as a pair. The pair is herein defined not only by two users but also by three or more uses.

For example, if a new pair is generated by combining three users, the user detection part 54 sequentially performs processing of identifying two arbitrary users out of the previous users and combining the two users and the new user to generate a plurality of new pairs each including three users.

The pair of this exemplary embodiment is a combination of two or more users and is not limited to the combination of two users.

For example, the user detection part 54 identifies previous users who have used the space 2 after a predetermined time point and generates new pairs by combining the previous users and the new user.

For example, the user detection part 54 identifies previous users who have used the space 2 within a past predetermined period before a reference time point when the new user uses the space 2 and generates new pairs by combining the previous users and the new user.

If a plurality of previous users are present, a plurality of new pairs are generated.

The user detection part 54 compares the new pairs generated in Step S203 and a plurality of previous pairs already stored in the pair information storage part 52 to determine whether any previous pair matches one of the new pairs (Step S204).

For example, if information on the previous pair and the new pair is information on names, the names are compared to determine whether the previous pair matches the new pair. For example, if information on the previous pair and the new pair is information on face photographs, the face photographs are compared by using a publicly-known face authentication technology to determine whether the previous pair matches the new pair.

If the user detection part 54 determines that a previous pair matches one of the new pairs, the user detection part 54 identifies and outputs a plurality of users based on the new pair (Step S205).

Specifically, the user detection part 54 outputs information on the plurality of users to an operator or the like. Thus, the operator or the like may identify the plurality of users who may be involved in object delivery.

In this exemplary embodiment, every time the user detection part 54 generates a new pair, information on the new pair is stored in the pair information storage part 52. Thus, pieces of information on the new pairs are sequentially accumulated in the pair information storage part 52 and, with an elapse of time, stored in the pair information storage part 52 as pieces of information on the previous pairs.

The user detection part 54 compares the plurality of new pairs generated in Step S203 and the previous pairs already stored in the pair information storage part 52 to determine whether any previous pair matches one of the new pairs.

If the user detection part 54 determines that a previous pair matches one of the new pairs, the user detection part 54 detects and outputs a plurality of users in the new pair.

Whether the pairs match each other is determined in consideration of the order of users in the pair.

Determination may be made that the pairs match each other even if the order of users in the pair differs between the pairs.

When the pairs are compared, determination may be made that the pairs match each other if the pluralities of users in the pairs match each other though the order of users in the pair differs between the previous pair and the new pair.

Objects may be delivered mutually by the plurality of users by using the space 2. The mutual delivery may be detected by determining that the pairs match each other even if the order of users in the pair differs between the pairs.

All the previous pairs stored in the pair information storage part 52 may be compared with the new pairs generated in Step S203.

For example, previous pairs generated after predetermined time and date out of the plurality of previous pairs stored in the pair information storage part 52 may also be compared with the new pairs generated in Step S203.

More specifically, a plurality of previous pairs generated within the past two years out of the plurality of previous pairs stored in the pair information storage part 52 may be compared with the new pairs generated in Step S203.

In other words, a plurality of previous pairs generated, for example, within a past predetermined period before a reference time point when the new pairs are generated may be compared with the new pairs generated in Step S203.

In this case, the user detection part 54 detects a pair (plurality of users) substantially if the space is used a plurality of times within a predetermined specific period by the pair.

The user detection part 54 may detect a pair (plurality of users) if the space is used a plurality of times within the predetermined period by the same pair and if the number of times of use is larger than a predetermined number of times.

Specifically, the pair may be detected when the space is used more than a specific number of times such as four times within the predetermined period by the same pair instead of being detected simply when the space is used a plurality of times.

The predetermined period may be short. For example, the user detection part 54 may detect a pair if the space is used a plurality of times on the same day by the same pair.

More specifically, the user detection part 54 compares the new pairs with previous pairs generated on the day when the new pairs are generated out of the plurality of previous pairs already stored in the pair information storage part 52.

If a new pair and a previous pair match each other, the user detection part 54 detects a plurality of users in the new pair.

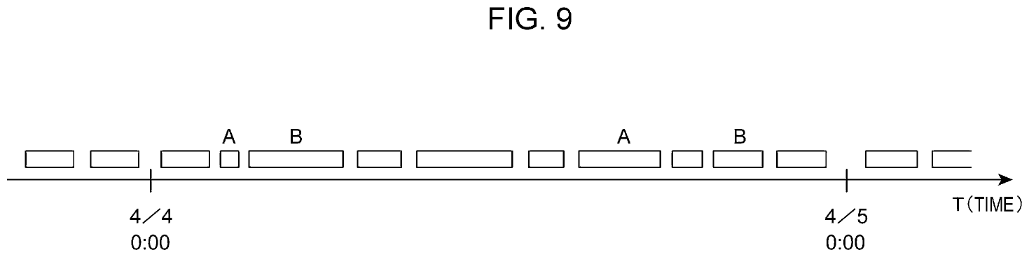

In an example illustrated in FIG. 9 (illustrating an example of usages of the space 2), the users A and B use the space 2 twice on the same day that is April 4. In this case, the user detection part 54 detects the users A and B.

Similarly to the above, if the space is used more than a predetermined number of times on the same day, the user detection part 54 may detect a plurality of users who use the space.

For example, if the space is used a plurality of times by one user and a different user subsequently to the one user, the user detection part 54 may detect the one user and the different user as the plurality of users.

In other words, for example, if the space is used a plurality of times by one user and a different user immediately after the one user, the user detection part 54 may detect the one user and the different user.

Specifically, if the space 2 is successively used a plurality of times by one user and a different user, the user detection part 54 may detect the one user and the different user as the plurality of users.

The term “successively” refers to a state in which no other user is present between two target users in time sequence. The term “successively” of this exemplary embodiment also corresponds to a state in which a vacant space that may be reserved is present between two target users in time sequence.

To detect a plurality of users who use the space successively, the user detection part 54 identifies, in Step S203, a previous user who has used the space 2 immediately before the new user and generates a new pair by combining the previous user and the new user.

Subsequently, the user detection part 54 identifies previous pairs each including a plurality of users who have used the space 2 successively out of the plurality of previous pairs already stored in the pair information storage part 52 and compares the identified previous pairs and the new pair. If any previous pair matches the new pair, the plurality of users in the new pair are detected.

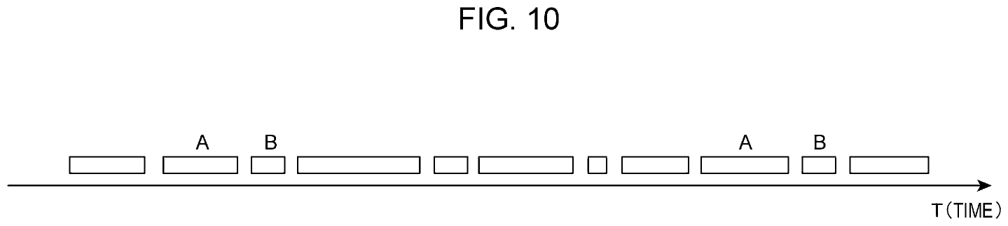

In an example illustrated in FIG. 10 (illustrating an example of usages of the space 2), the space is used twice by the user A and the user B immediately after the user A. In this case, the user detection part 54 detects the users A and B.

Similarly to the above, if the space 2 is successively used a plurality of times within a predetermined period by the user A and the user B, the user detection part 54 may detect the users A and B.

If the space 2 is successively used more than a predetermined number of times within the predetermined period by the user A and the user B, the users A and B may be detected.

To demonstrate the example illustrated in FIG. 7 from another viewpoint, the user detection part 54 detects a pair who uses the space 2 a plurality of times at close time points.

In other words, the user detection part 54 detects a plurality of users who have a relationship in which a difference between the time points when the space 2 is used falls within a predetermined range and who use the space 2 a plurality of times under the condition that the difference falls within the predetermined range.

In the example illustrated in FIG. 7, the space 2 is repeatedly used by the user A and the user B and a difference T1 between the time point when the space 2 is used by the user A and the time point when the space 2 is used by the user B falls within three hours in every use.

In other words, in the example illustrated in FIG. 7, the difference T1 between the time point when the space 2 is used by the user A and the time point when the space 2 is used by the user B falls within the predetermined range in every use.

In the example illustrated in FIG. 7, the “difference between the time points of use” is an elapsed period from a time point when the preceding user A finishes using the space 2 to a time point when the succeeding user B starts using the space 2.

For example, the “difference between the time points of use” may be an elapsed period from a time point when the preceding user A starts using the space 2 to a time point when the succeeding user B starts using the space 2, or an elapsed period from a time point when the preceding user A finishes using the space 2 to a time point when the succeeding user B finishes using the space 2.

Thus, the user detection part 54 may detect the plurality of users having the relationship in which the difference between the time points of use falls within the predetermined range when the users use the space 2 a plurality of times.

More specifically, the user detection part 54 generates a new pair including the plurality of users having the relationship in which the difference between the time points of use falls within the predetermined range.

Then, the user detection part 54 identifies a plurality of previous pairs each having the relationship in which the difference between the time points of use falls within the predetermined range out of the plurality of previous pairs already stored in the pair information storage part 52.

Then, the user detection part 54 compares the identified previous pairs and the new pair. If any previous pair matches the new pair, the user detection part 54 detects the plurality of users in the new pair.

If a plurality of users having a large difference between the time points of use of the space 2 are combined as a pair, there is an increasing possibility that a plurality of users having no relationship are combined as a pair.

If the plurality of users having the relationship in which the difference between the time points of use falls within the predetermined range are combined as a pair, there is an increasing possibility that a plurality of users having a relationship are combined as a pair.

For example, object delivery may take place such that the object is hidden under the desk arranged in the space 2. In this case, the object delivery is accomplished even if the succeeding user who will obtain the object does not come immediately after the preceding user who has placed the object.

The pair who attempts the object delivery by hiding the object may be detected by detecting, as a pair, the preceding user and the succeeding user even if both the users do not appear successively.

If a preceding user and a succeeding user having a large difference between the time point when the space is used by the preceding user and the time point when the space is used by the succeeding user are combined as a pair, there is an increasing possibility that a pair having no relationship is detected. Thus, erroneous detection is likely to occur.

The erroneous detection becomes unlikely to occur if the users having the relationship in which the difference between the time points of use falls within the predetermined range are combined as a pair.

Similarly to the above, the user detection part 54 may detect a plurality of users who use the space a plurality of times within a predetermined period under the condition that the difference falls within the predetermined range.

Similarly to the above, the user detection part 54 may detect a plurality of users who use the space more than a predetermined number of times within the predetermined period under the condition that the difference falls within the predetermined range.

Next, other detection examples are described.

The user detection part 54 may detect a plurality of users who use the space 2 at different time points and are involved in object delivery via the space 2.

Unlike the cases described above, the user detection part 54 detects the plurality of users even if the plurality of users use the space 2 only once but are involved in the object delivery via the space 2.

Specifically, in this exemplary embodiment, a preceding user may deliver an object to a succeeding user when the preceding user places the object in the space 2.

In the processing described above, the object delivery or the like is indirectly detected by detecting the plurality of times of use. In this processing, the object delivery is detected to detect the plurality of users involved in the delivery. For example, the object delivery is detected by analyzing images obtained by the photographing apparatus 24 (see FIG. 2).

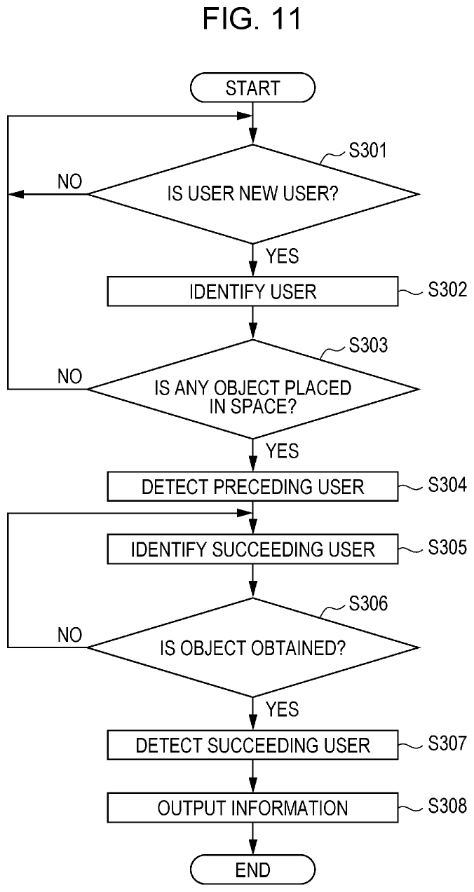

FIG. 11 is a flowchart illustrating a flow of processing of detecting a plurality of users involved in object delivery. FIG. 11 illustrates another example of the processing in Step S102.

Similarly to the above, the user detection part 54 determines whether a user is a new user every time a new usage is grasped by the usage grasping part 53 (Step S301).

In other words, the user detection part 54 determines whether the user who uses the space 2 is switched to a new user. If the user is a new user, the user detection part 54 identifies the user (Step S302). As described above, the user identification includes acquiring, for example, a face photograph of the user.

Subsequently, the user detection part 54 determines whether an object is placed in the space 2 by analyzing an action of the new user who is using the space 2 and a state of the space 2 after the new user exits from the space 2 (Step S303).

In other words, the user detection part 54 determines whether an object is placed in the space 2 by analyzing a photographing result obtained by the photographing apparatus 24. If the user detection part 54 determines that an object is placed, the user detection part 54 detects the new user who has placed the object (hereinafter referred to as “preceding user”) (Step S304).

Then, the user detection part 54 determines whether a user is a new user every time a new usage is grasped by the usage grasping part 53. If a new user is present, the user detection part 54 identifies this user (hereinafter referred to as “succeeding user”) (Step S305).

Subsequently, the user detection part 54 determines whether the object placed in the space 2 is obtained by analyzing an action of the succeeding user who is using the space 2 and a state of the space 2 after the succeeding user exits from the space 2 (Step S306).

If the user detection part 54 determines that the object is obtained, the user detection part 54 detects the succeeding user who has obtained the object (Step S307). If the user detection part 54 determines that the object is not obtained in Step S306, the user detection part 54 repeats the processing in Step S306 and subsequent steps while awaiting a new succeeding user.

Subsequently, the user detection part 54 outputs information on the preceding user who has placed the object in the space 2 and the succeeding user who has obtained the object from the space 2 (Step S308). For example, the user detection part 54 outputs, to the operator, information on the preceding user detected in Step S304 and the succeeding user detected in Step S307.

The user detection part 54 may detect not only all the users involved in the object delivery but also, for example, a plurality of users involved in delivery in which an elapsed period from the time when an object is placed in the space 2 to the time when the object is obtained falls within a predetermined period.

Specifically, the user detection part 54 may detect a preceding user and a succeeding user if an elapsed period from the time when an object is placed in the space 2 by the preceding user to the time when the object is obtained by the succeeding user falls within three hours.

If the elapsed period is long, a succeeding user having no relationship with the preceding user is likely to obtain the object.

A plurality of users having a relationship at strong possibility may be detected by detecting a plurality of users involved in delivery under the condition that the elapsed period falls within the predetermined period.

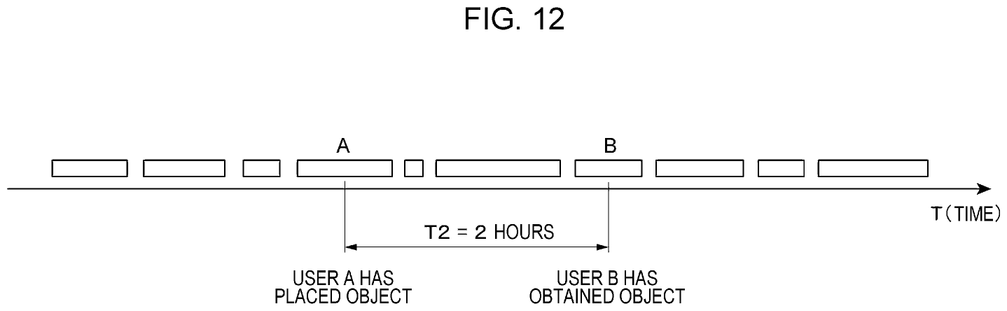

FIG. 12 (illustrates usages of the space 2) demonstrates a situation in which the preceding user A who uses the space 2 first places an object in the space 2 and then the succeeding user B who uses the space 2 later obtains the object. In the example illustrated in FIG. 12, an elapsed period T2 from the time when the object is placed in the space 2 to the time when the object is obtained is two hours shorter than three hours that are the predetermined period.

In this exemplary embodiment, the user detection part 54 detects the preceding user A and the succeeding user B under that situation.

In this exemplary embodiment, if an object is delivered, the delivery detection part 55 also detects the delivery.

In this exemplary embodiment, the user detection part 54 detects the plurality of users involved in the object delivery and the delivery detection part 55 detects the delivery. In this exemplary embodiment, information indicating that the object is delivered is output to the operator or the like.

Thus, the operator may grasp the object delivery and the plurality of users involved in the object delivery.

In this exemplary embodiment, it may be confirmed whether the preceding user has placed and delivered the object to the succeeding user. In this exemplary embodiment, it may also be confirmed whether the object placed by the preceding user is delivered to a predetermined succeeding user. This confirmation is made by the space management server 5.

In this case, it is necessary that the preceding user make a request in advance as reservation information in that an object will be delivered and a specific succeeding user be set as request information. Specifically, the user who will place the object specifies in advance a different user who will receive the object. Thus, it may be confirmed whether the object delivery is accomplished properly. Similarly, an error notification that an unintended succeeding user has received the object may be given to the preceding user and the succeeding user who would originally receive the object.

The preceding user may visit again the place where the object is placed and pick up the object. In this case, determination is made that the preceding user has come to pick up the object left behind. Thus, no record is kept. Alternatively, the operator may be informed of a record showing that the preceding user has successfully picked up the object left behind.

In this exemplary embodiment, the object placement detection part 56 detects that an object is placed in the space 2. In this exemplary embodiment, the object obtainment detection part 57 detects that an object placed in the space 2 is obtained.

For example, the space 2 may be used for regular delivery of an object. If it is detected that the object is placed in and obtained from the space 2, the user or the like may be notified of, for example, information on the progress of the object delivery or information indicating that the object is delivered without trouble.

For example, the object placement detection part 56 detects that an object is placed in the space 2 by analyzing an image obtained by the photographing apparatus 24. For example, the object placement detection part 56 may detect that an object is placed by acquiring information input through operation for the user terminal 4 by the user.

Specifically, the processing may be performed such that the user inputs, via the user terminal 4 or the like, information indicating that an object is placed in the space 2. In this case, the object placement detection part 56 detects that the object is placed by acquiring the information input through the operation for the user terminal 4 or the like by the user.

Similarly, the object obtainment detection part 57 detects that an object placed in the space 2 is obtained by analyzing an image obtained by the photographing apparatus 24. Similarly to the above, the object obtainment detection part 57 may detect that an object is obtained by, for example, acquiring information input through operation for the user terminal 4 by the user.

Specifically, the processing may be performed such that the user inputs, via the user terminal 4 or the like, information indicating that an object placed in the space 2 is obtained by the user. In this case, the object obtainment detection part 57 detects that the object is obtained by acquiring the information input through the operation for the user terminal 4 by the user.

### (Others)

In the above, a plurality of users who satisfy a specific relationship are detected based on the actual usages of the space 2. The plurality of users who satisfy the specific relationship may be detected based on reservation statuses of the space 2.

Specifically, reservation information of the space 2 is acquired and, for example, a plurality of users who use the space 2 a plurality of times at different time points may be detected based on the reservation information.

In this case, each type of processing described above may similarly be applied to the processing that is based on the reservation statuses.

Specifically, to detect a plurality of users based on the reservation statuses, the user detection part 54 may detect a plurality of users who use the space a plurality of times within a predetermined period similarly to the above.

The user detection part 54 may detect a plurality of users who use the space a plurality of times on the same day.

If the space is used a plurality of times by one user and a different user subsequently to the one user, the user detection part 54 may detect the one user and the different user as the plurality of users.

If the space is used a plurality of times within a predetermined period by the one user and the different user, the user detection part 54 may detect the one user and the different user as the plurality of users.

The user detection part 54 may detect a plurality of users who have a relationship in which a difference between the time points when the space 2 is used (reserved) falls within a predetermined range and who use the space 2 a plurality of times under the condition that the difference falls within the predetermined range.

The user detection part 54 may detect a plurality of users who use the space a plurality of times within a predetermined period under the condition that the difference falls within the predetermined range.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system, comprising:
a grasping unit that grasps usages of a specific place that is used by users; and
a user detector that detects a plurality of users who use the specific place at different time points and satisfy a predetermined specific condition based on the usages grasped by the grasping unit.

2. The information processing system according to claim 1, wherein the user detector detects a plurality of users who use the specific place a plurality of times at the different time points.

3. The information processing system according to claim 2, wherein the user detector detects a plurality of users who use the specific place the plurality of times within a predetermined period.

4. The information processing system according to claim 2, wherein the user detector detects a plurality of users who use the specific place the plurality of times on the same day.

5. The information processing system according to claim 1, wherein, when the specific place is used a plurality of times by one user and a different user subsequently to the one user, the user detector detects the one user and the different user as the plurality of users.

6. The information processing system according to claim 5, wherein, when the specific place is used the plurality of times within a predetermined period by the one user and the different user, the user detector detects the one user and the different user as the plurality of users.

7. The information processing system according to claim 1, wherein the user detector detects a plurality of users who have a relationship in which a difference between the time points when the specific place is used falls within a predetermined range and who use the specific place a plurality of times under a condition that the difference falls within the predetermined range.

8. The information processing system according to claim 7, wherein the user detector detects a plurality of users who use the specific place the plurality of times within a predetermined period under the condition that the difference falls within the predetermined range.

9. The information processing system according to claim 1, wherein the user detector detects a plurality of users who use the specific place at the different time points and are involved in delivery of an object via the specific place.

10. The information processing system according to claim 9, wherein the user detector detects a plurality of users involved in delivery in which an elapsed period from a time when the object is placed in the specific place to a time when the object is obtained falls within a predetermined period.

11. The information processing system according to claim 1, further comprising a delivery detector that detects that an object is delivered via the specific place.

12. The information processing system according to claim 1, further comprising an object placement detector that detects that an object is placed in the specific place.

13. The information processing system according to claim 1, further comprising an object obtainment detector that detects that an object placed in the specific place is obtained.

14. The information processing system according to claim 1, further comprising a confirmation unit that confirms whether a different user specified by a user who has placed an object in the specific place obtains the object.

15. An information processing system, comprising:
a grasping unit that grasps reservation statuses of a specific place that is used by users; and
a user detector that detects a plurality of users who use the specific place at different time points and satisfy a predetermined specific condition based on the reservation statuses grasped by the grasping unit.

16. A non-transitory computer readable medium storing a program causing a computer to execute a process comprising:
grasping usages of a specific place that is used by users; and
detecting a plurality of users who use the specific place at different time points and satisfy a predetermined specific condition based on the grasped usages.

17. A non-transitory computer readable medium storing a program causing a computer to execute a process comprising:
grasping reservation statuses of a specific place that is used by users; and
detecting a plurality of users who use the specific place at different time points and satisfy a predetermined specific condition based on the grasped reservation statuses.
